(19) United States
(12) Patent Application Publication
(10) Pub. No.: US 2017/0078145 A1
(43) Pub. Date: Mar. 16, 2017

(54) SIMPLIFIED CONFIGURATION OF NETWORK DEVICES USING SCANNED BARCODES

(71) Applicant: Kodak Alaris, Inc., Rochester, NY (US)

(72) Inventors: Carl Tesavis, Rochester, NY (US); Lawrence Bernstein, Rochester, NY (US)

(73) Assignee: KODAK ALARIS, INC., Rochester, NY (US)

(21) Appl. No.: 14/855,913

(22) Filed: Sep. 16, 2015

(51) Int. Cl. H04L 12/24; G06K 7/10; G06K 7/14

(52) U.S. Cl. CPC H04L 41/0816; G06K 7/1413; G06K 7/10722

(57) ABSTRACT

The present invention is directed to systems and methods for configuring network devices that include native scanning or image-reading elements. Network configuration information is provided in a scannable image. A network device reads the scannable image and extracts configuration data from the image. The device then uses the extracted configuration data to configure the device to operate on a desired network.

### FIELD OF THE INVENTION

The present invention is directed to configuring embedded hardware controllers of devices that include a native scanning or image-reading elements, and in particular to configuring devices including scanning or image-reading elements on networks using encrypted barcodes scanned by the devices that contain all information necessary to complete the network configuration.

### BACKGROUND OF THE INVENTION

Configuring embedded devices, such as office equipment, to work on local or wide area networks can be complex, and may require manual installation or the help of IT staff. The need to configure new devices on networks often drives enhanced operator control panels (OCPs) at higher cost with larger screens and with more complex input capabilities (touch screens or full keyboards) than is required for normal device functionality, which may only need a small LCD display with a few buttons. Often networkable device configuration is so complex the user requires assistance of IT professionals. Manual installation typically requires a user to select a wireless SSID network from a network list displayed on the device, or a computer connected to the device. Once the user has selected the SSID network that they would like to connect to, the user must then select the wireless security protocol for that network. Lastly, the user enters the password for the selected network in order to configure the device for use on the network. This manual installation may be performed through a user interface on the device itself, when available, or through a computer connected to the device.

There remains a need for network security and low-cost, compact network devices. What is needed is an efficient mechanism to properly configure the embedded network controller hardware of devices that natively include a scanning or imaging element without extensive manual intervention and input.

### SUMMARY OF THE INVENTION

The present invention is directed to systems and methods for configuring network devices having native scanning or imaging elements. The network configuration information necessary for the device is encoded into a scannable image, such as a barcode, which may then be read by the scanning or imaging element of the device. A processor in the embedded device, or in a computer or server in communication with the device, processes the information from the scannable image and extracts the configuration data. The processor then executes a configuration process using the extracted data, thereby programming network controller hardware in the device to work correctly on desired networks. This provides a simplification of the configuration process of the specified class of devices to work on a wide variety of network infrastructures without the use of a complex and expensive embedded OCP interfaces or the direct intervention of high paid IT personnel.

### BRIEF DESCRIPTION OF THE DRAWINGS

FIG. 1 is an example of the network configuration data embedded in a scannable image.

FIG. 2 is an illustration of network devices and components used in configuring devices to work on a network using an encoded scannable image.

FIG. 3 is an illustration of a process to configure devices on a network using an encoded scannable image.

FIG. 4 is an illustration of the process to create a scannable image containing the network configuration data.

### DETAILED DESCRIPTION

The present invention is directed to a system and method for configuring devices including a scanner or imaging element on a network. The scanner or imaging device may be an integral part of the device, or may be added to devices not typically having a scanner or imaging element of the purposes of providing simplified network configuration of the device as described herein. For example, the device may be document scanners, all-in-one printers, copiers and devices with 2-D imagers like cameras.

The system includes computing components configured to execute a software application on a local processor or as a WEB application hosted by the device manufacturer. The application collects the required network configuration information for the device as computer-readable text, such as ASCII text, Unicode text, or other text formats such as XML, HTML or any format able to be decoded by a computer. In order to obtain the network configuration information, the application may utilize the Network Name (SSID) and security settings of the network stored in a computer, or the SSID may be entered by the user. The network password may be manually entered by a user, or may be previously entered and stored in a file on a computer, where it may accessed and included in the computer-readable text information. As noted above, the network configuration information may be collected as ASCII text.

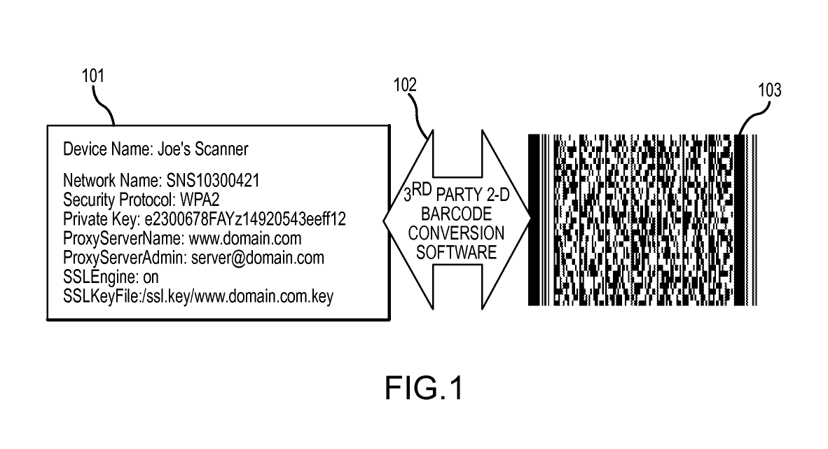

As seen in FIG. 1, this configuration information 101 may include Device Network Name or IP Address, including any subnet or router information related to the IP Address, Dynamic Host Configuration Protocol (DHCP) information, Domain Name Server (DNS) information, a Network Encryption Protocol, and any Private Key or other encryption/decryption information necessary to provide access to the information. This information may also include but is not limited to any configuration parameters able to be interpreted by the scanner controller to allow the devices function to be customized and more able to be used efficiently and securely in the customer's environment. This could include but is not limited to the location of other similar devices in the form of network addresses or network names, scanning profiles in the form of lists of scanning parameters such as capture resolution, capture format (24 bit color 8 bit gray or binary etc.), capture as simplex or duplex, enable/disable various forms of fault detection (multi feed detection, document protection etc.), enable/disable all forms of image processing enhancements (deskew image, white balance, background smoothing, text enhancement etc.) etc. Once the required network configuration data is collected, a processor converts the information 101 to computer readable text representation, such as an ASCII representation. The computer readable text representation is then encrypted using a private key and encoded as shown at 102 into a scannable image 103. The scannable image 103 may be a standard 2-D barcode, a 1-D barcode, QR code, Matrix barcode, or any other readable coded image. The scannable image may also be an image of text, recognizable by the device through optical character recognition (OCR). This scannable image 103 may then be printed in a format capable of being scanned or imaged using the scanner or imaging elements of the device being added to the network.

The device being added to the network is configured to scan, or image, and digitize the printed scannable image. The scanning process results in a digital image of the scannable image containing the network configuration data, which may be encrypted and encoded. The digital image is then decoded by the device's embedded processor, resulting in encrypted ASCII text. The encrypted ASCII text is then decrypted using the same private key encryption that was used by the application to encrypt it. Once decrypted, the device will have access to the required configuration data necessary to program its network controller, such as an Ethernet controller, to enable it to function on the network as intended.

The system and method allow for configuring a device to work on a network with a configuration process that can be done remotely from the device. The configuration process may be implemented by a user with a very easy to use and intuitive application presented to the user on an interface. The user interface may include an input and an output, such as a full keyboard or large touch screen with large color LCD display. The user interface allows the configuration data collection process to be user friendly, yet does not add unnecessary cost to the embedded device.

As noted above, the configuration application may be run remotely from the device itself. This allows, but does not require, a centralized expert like an IT professional to do the configuration for users not comfortable with even the simplified process described herein. This also would allow such an expert to securely send the configuration to one or more end users as an e-mail attachment or other electronic message. The electronic message would comprise a scannable image, such as text, recognizable by the device through optical character recognition (OCR), or a scannable bar code or other readable coded image. A recipient of the electronic message could print a hard copy of the configuration information using a printer or similar device. The hard copy printout could then be scanned or imaged using the scanner or imaging elements of the device being added to the network.

An extension of this concept includes the application of scannable image encoding of scanner batch setup data or profile information. The scannable image may comprise encoded Profile information for a given device, including the desired printer color and dots-per-inch settings, as well as scanner image crop and deskew processing, scanner file output type, and scanner file output location settings. The scannable image may also comprise scanner batch setup information, including scanner image crop and deskew processing, scanner file output type, and scanner file output location settings limited to the batch of scanned documents currently being processed. Sheets containing this profile information or batch setup data could be authored at the user's personal computer or workstation in a simple text editor or with a Windows application with pull downs and check boxes. The text may then be fed into conversion software creating the scannable image. This image can subsequently be printed on a sheet of paper or cardstock. This Profile Sheet could then be the first document in a batch to be scanned on a network scanner, or other device with a scanner or imaging element desired to be added to a network. The scanning device may be configured to assume a profile sheet is present. If the device is so configured, the device may alert the user if the first document scanned is not a profile sheet, or it may assume a default setup. The scanning device may also be configured to a “disable” mode, where the device treats profile sheets as though they are ordinary documents (i.e., scanning the sheet and outputting the scanned image to the output location set for the device). Finally, sheets containing scannable images could also be included intermingled within the batch to change configuration or network destination and scanning parameters within a batch. The scannable image profile sheet would minimally contain the User ID and optionally other data previously described as scanning profile information such as Resolution, Color, Binary, Grayscale, or Auto Orient, which is being changed from the standard user scanning profile associated with their user ID retrieved from the network following a successful login.

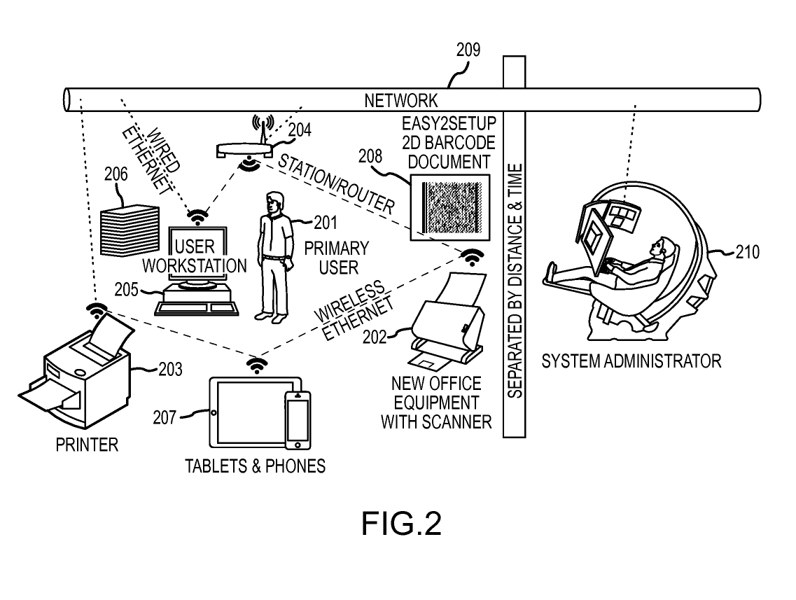

As seen in FIG. 2, a user 201 may be the end user or the locally responsible point of contact administrator for New Office Equipment 202. The user 201 may in many cases have a limited understanding of issues related to configuring a device on a wired or wireless Ethernet network. New Office Equipment 202 is equipped with scanner means. User 201 may have access to printer 203 to print the Easy2Setup scannable image 208 (see also 103, FIG. 1). Preferably, a remote system administrator 210 will distribute the Easy2Setup scannable image 103 to user 201 by emailing the image 208 to user 201 via user 201's workstation 205. Workstation 205 is connected to a corporate network or internet 209 via router 204, and is connected to printer 203. Workstation 205 provides means to transmit scannable image 208 to printer 203 for printing. Workstation 205 has or has access to persistent storage means where a number of Easy2Setup scannable images could be archived 206 for later use or sharing with others. Workstation 205 also has means for using New Office Equipment 202 (e.g., by means of device drivers or other hardware configuration data). Alternatively, Workstation 205 could be replaced by mobile workstation 207 comprising the same features as Workstation 205.

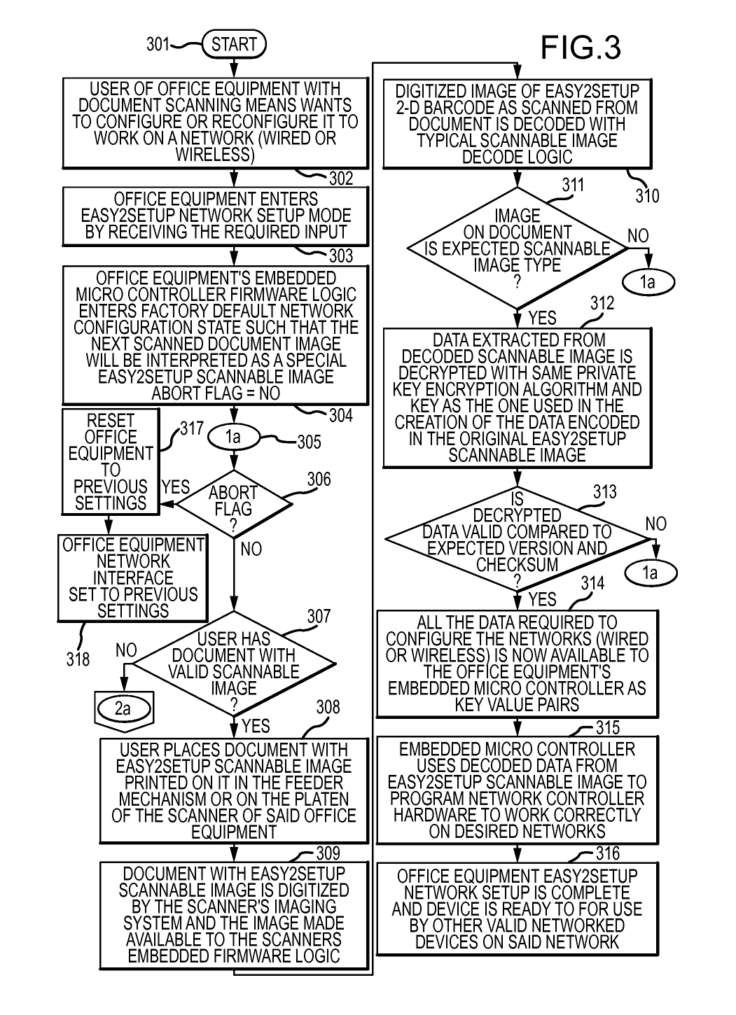

FIG. 3 illustrates the Easy2Setup process, which begins at START 301. A user 201 of office equipment of document scanning means may want 302 to configure or reconfigure it to work on a wired or wireless network. The Office Equipment 202 enters 303 Easy2Setup Network Setup mode by receiving the required input (by, for example, a user setting the device to an input mode). Upon entering Easy2Setup mode, the Office Equipment's Embedded Microcontroller firmware logic enters 304 a factory default network configuration state such that the next scanned document image will be interpreted as an Easy2Setup scannable image. The firmware logic also sets the abort flag to “No” and advances processing to step 1a 305. At step 1a 305, if the abort flag is set to “No.” the processing advances to step 306. If the abort flag is set to “Yes,” the Office Equipment will reset its previous settings 317 and previous network settings 318, and then terminate Easy2Setup processing.

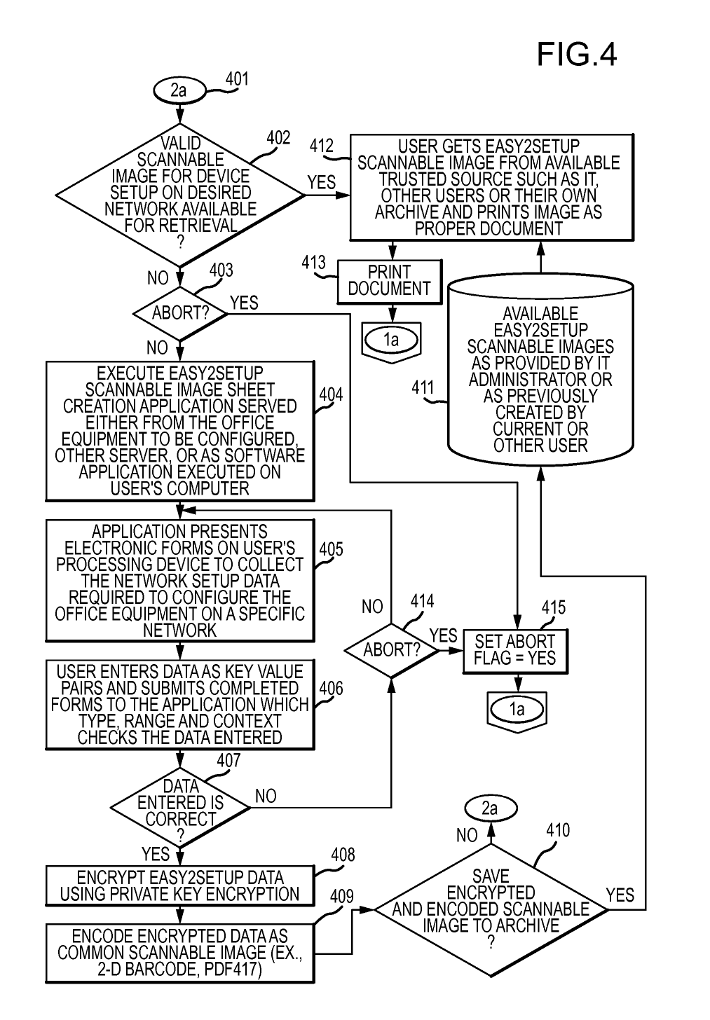

At step 306, if the user does not have a valid Easy2Setup scannable image 208 available, the user proceeds to step 2a (401, FIG. 4 below). If the user does have an image 208 available, the user at step 307 places image 208 in the Feeder mechanism or on the plate of the scanner of Office Equipment 202. At step 308, the image 208 is digitized by Office Equipment 202's scanner's imaging system, and the image is made available to the scanner's embedded firmware logic. The digitized image is then decoded at step 309 using logic depending on the type of image scanned. For example, a 2d barcode or QR code can be interpreted using barcode or QR code decode logic. Text can be interpreted via OCR. At step 310, the logic checks to see if the scanned image is of an expected type. If not, the process returns to step 1a (305) to allow the user to input another Easy2Setup scanned image. If the scanned image is of an expected type, and the image contained encrypted data, then the data extracted may be decrypted 311 using the same private key encryption algorithm and key used in the creation of the Easy2Setup scanned image 208. As step 312, if the decryption was valid (or if no decryption was performed), the processing proceeds to step 313. If not, processing returns to step 1a (305) to allow the user to input another Easy2Setup scanned image.

At step 313, the data contained within the scannable image is now available to the Office Equipment 202's microcontroller as a series of key-value pairs. The Office Equipment microcontroller at step 314 uses these key-value pairs to program network controller hardware to operate on a network as specified. At step 315, processing is complete and Office Equipment 202 is configured to operate on network 209.

FIG. 4 describes the process of creating an Easy2Setup scannable image. The process begins at step 2a (401). First (402), if the user wants to retrieve a valid Easy2Setup scannable image from a storage medium, such as an optical drive, magnetic drive, flash drive, disk, or network, or from another source, such as other users or an information technology administrator (all represented by storage medium 411), and if that image is available, the user gets the scannable image 412 and prints the image 413. The user is then able to proceed to use the image to configure the office equipment at step 1a of FIG. 3 (305).

If a valid Easy2Setup scannable image is not available, the process checks to see if the user wants to abort the process 403. If yes, then the abort flag is set to “Yes” and processing proceeds to step 1a (305). If the user does not wish to abort, the Easy2Setup scannable image creation program 404 is started. Easy2Setup scannable image creation program 404 may be served from Office Equipment 202, another server on network 209, another server not on network 209, or may be a client application on user's workstation 205 or mobile workstation 207. Program 404 presents electronic forms 405 on the user's processing device to collect network setup data required to configure Office Equipment 202 to a specific wired or wireless network. At step 406, the user enters the data as key-value pairs and submits the completed form to the Program. The program performs range and context checks against the data entered at step 407.

If the data entered is incorrect, the process asks the user at step 414 if an abort is desired. If so, the abort flag is set to “Yes” and processing proceeds to step 1a (305). If not, processing proceeds to step 405 for user to reenter form data.

If the checks against the data at step 407 show that the data entered is correct, then the data may be encrypted at step 408 using private key encryption or other forms of encryption. Alternatively, no encryption need be performed at step 408. After encryption (if performed) the data is be encoded into a scannable image at step 409. For example, the data may be encoded as a standard 2-D barcode, a 1-D barcode, QR code, Matrix barcode, or any other readable coded image. The scannable image is then 410 saved to an archive, and processing may return to step 2a (401) and provided to storage medium 411.

1. A device for configuration on a network, comprising:
an imaging element configured to capture data representing a scannable image;
an embedded network controller; and
a processor and memory;
wherein the processor is configured to:
receive data from the imaging element representing the scannable image;
process the data representing the scannable image to extract network configuration data; and
execute a configuration process using the extracted network configuration data, thereby programming the embedded network controller to work on the network.

2. The device of claim 1, wherein the network configuration data is extracted as computer-readable text information.

3. The device of claim 2, wherein the computer-readable text information is ACII text, Unicode text, XML, or HTML.

4. The device of claim 1, wherein the network configuration data comprises at least one of the device network name, the device IP address, dynamic host configuration protocol information, domain name server information, a network encryption protocol, and an encryption or decryption key.

5. The device of claim 1, wherein processor is configured to process the data representing the scannable image to extract configuration data for the imaging element of the device.

6. The device of claim 5, wherein the configuration data for the imaging element comprises at least one of capture format, capture resolution, capture as simplex or duplex, enabling or disabling of at least one form of fault detection, and enabling or disabling of at least one form of image enhancement.

7. The device of claim 1, wherein the device is configured to encrypt the network configuration data before encoding the network configuration data into a scannable image, and wherein the device is configured to decrypt the network configuration data after decoding the scannable image.

8. The device of claim 1, wherein the scannable image is at least one of a 2-D barcode, a 1-D barcode, a QR code, or a matrix barcode.

9. The device of claim 1, wherein the scannable image is an image of text, and wherein the device decodes the network configuration data through optical character recognition.

10. The device of claim 1, further comprising a user interface configured to display instructions and options to a user for implementing the network configuration.

11. A method of configuring a network device on a network, comprising:
scanning a scannable image with an imaging device, wherein the scannable image is encoded with network configuration data;
sending the scanned image to a processor;
decoding, by the processor, the network configuration data from the scannable image;
extracting, by the processor, the network configuration data; and
configuring a network controller in the network device to operate on the network using the extracted network configuration data.

12. The method of claim 11, wherein the network configuration data is computer-readable text information.

13. The method of claim 12, wherein the computer-readable text information is ACII text, Unicode text, XML, or HTML.

14. The method of claim 11, wherein the network configuration data comprises at least one of the device network name, the device IP address, dynamic host configuration protocol information, domain name server information, a network encryption protocol, and an encryption or decryption key.

15. The method of claim 11, wherein the network configuration data additionally includes configuration data for the imaging element of the device.

16. The method of claim 13, wherein the configuration data for the imaging element comprises at least one of capture format, capture resolution, capture as simplex or duplex, enabling or disabling of at least one form of fault detection, and enabling disabling of at least one form of image enhancement.

17. The method of claim 11, further comprising encrypting the network configuration data before encoding the network configuration data into a scannable image, and decrypting the network configuration data after decoding the scannable image.

18. The method of claim 11, wherein the scannable image is at least one of a 2-D barcode, a 1-D barcode, a QR code, or a matrix barcode.

19. The method of claim 11, wherein the scannable image is an image of text, and wherein the device decodes the network configuration data through optical character recognition.

20. The method of claim 11, further comprising determining whether the decoded data indicates that the scannable image was an expected type.

21. A method of creating a scannable image sheet for configuring a device with an image capturing element on a network, comprising:
collecting network setup information required to configure the device on the network;
encoding the network setup information as a scannable image;
saving the encoded scannable image to a database; and
printing the scannable image.

22. The method of claim 21, where the network setup information is encrypted.

23. The method of claim 22, where the encrypted network setup information is encoded and saved as a scannable image to a database.
